(19) United States
(12) Patent Application Publication
(10) Pub. No.: US 2026/0010862 A1
(43) Pub. Date: Jan. 8, 2026

(54) METHOD AND SYSTEM FOR MANAGING DELIVERY RESOURCES

(71) Applicant: OCADO INNOVATION LIMITED, Hatfield (GB)

(72) Inventors: Tim STEINER, Hatfield (GB); Piotr SZOPA, Krakow (PL); Bartosz MALOCHA, Krakow (PL); Lukasz OPALUCH, Krakow (PL)

(21) Appl. No.: 19/274,711

(22) Filed: Jul. 21, 2025

Related U.S. Application Data
(63) Continuation of application No. PCT/EP2024/051012, filed on Jan. 17, 2024.

(30) Foreign Application Priority Data
Jan. 20, 2023 (GB) 2300866.7

(51) Int. Cl. G06Q 10/0834; G06Q 10/0631; G06Q 10/109

(52) U.S. Cl. CPC G06Q 10/0834; G06Q 10/06314; G06Q 10/06315; G06Q 10/1097

(57) ABSTRACT

A method of managing delivery resources comprising, for each of a plurality of delivery resources, defining a resource finalization time, an advance availability period, a deferred availability period, and a deferred availability release time. The method then further comprises, upon receiving a delivery slot request for an order, identifying delivery time slots for the order that can be fulfilled by one or more of the plurality of delivery resources, enabling selection of any one of identified delivery time slots, receiving a selection of one of the identified time slots and assigning the order to any of the plurality of delivery resources that can fulfil the selected delivery time slot and, after the resource finalization time of the assigned delivery resource, sending instructions to a storage and retrieval portion of the system to initiate picking and packing of the order, and loading of the order on to the delivery resource.

### RELATED APPLICATIONS

This application is a continuation of PCT Application No. PCT/EP2024/051012, filed 17 Jan. 2024 and entitled “Method and System for Managing Delivery Resources,” which claims priority to UK Patent Application No. GB2300866.7, filed 20 Jan. 2023 and entitled “Method and System for Managing Delivery Resources”; all of which applications are incorporated herein by reference in their entireties.

### FIELD OF THE INVENTION

The disclosure herein relates to methods of managing delivery resources and systems for implementing such methods. In particular, the present disclosure provides methods of managing the assignment of orders to a plurality of delivery resources that enables the delivery resources to be used to service orders having differing lead times, and systems for implementing such methods.

### BACKGROUND

Typically, customers of online grocery delivery services select a date and a time slot for their delivery. The customer then selects the items that they wish to have delivered and saves the order. It may be possible for the customer to subsequently update their order, for example by adding in further items or deleting items from the existing order, until a cut-off time. Once the cut-off time has passed then the order can no longer be altered and it is possible for the orders to be assigned to delivery vehicles such that the routes of the delivery vehicles can be optimised, for example to reduce travel times, to minimise the number of vehicles required to deliver all of the orders, to vehicle emissions, etc. The orders can then be picked, the delivery containers loaded onto the appropriate delivery vehicle and then the vehicles can deliver the ordered goods in the requested time slot. Typically, the cut-off time for submitting and/or editing an order occurs on the day before the date of the delivery. This then gives the service provider a lead time of at least 8 hours to pick, pack, load and deliver the order to the delivery location.

It is against this background that the present invention has been devised.

### SUMMARY OF THE INVENTION

According to a first aspect, there is provided method of managing delivery resources. The method comprises for each of a plurality of delivery resources, defining a resource finalization time, an advance availability period, a deferred availability period, and a deferred availability release time. The method further comprises, upon receiving a delivery slot request for an order, identifying delivery time slots for the order that can be fulfilled by one or more of the plurality of delivery resources, enabling selection of any one of identified delivery time slots, receiving a selection of one of the identified time slots and assigning the order to any of the plurality of delivery resources that can fulfil the selected delivery time slot. The step of identifying delivery time slots for the order that can be fulfilled by one or more of the plurality of delivery resources comprises identifying the delivery resources that are capable of delivering the order and, for each of the identified delivery resources: if an order request time is before the deferred availability release time for the delivery resource, identifying any available delivery time slots that are within the advance availability period of the delivery resource; and if an order request time is after the deferred availability release time and before the resource finalization time, identifying any available delivery time slots that are within any of the advance availability period and the deferred availability period of the delivery resource. The method then further comprises, after the resource finalization time of the assigned delivery resource, sending instructions to a storage and retrieval portion of the system to initiate picking and packing of the order, and loading of the order on to the delivery resource. An order may comprise a request to deliver one or more items and a delivery location for the one or more items.

Conventionally, orders having different lead times are delivered using different delivery resources. For example, it is typical for long lead time orders to be delivered using a first set of delivery resources, whilst a separate second set of delivery resources is reserved for delivering short lead time orders. In contrast, the method of assigning orders to delivery resources as described herein provides that orders having different lead times can be serviced without the need to provide additional or alternative delivery resources. In doing so, the method described herein reduces the costs of delivering orders that have different lead times. In addition, the methods described herein provide that the usage of existing delivery resources can be optimised, as more orders can be fulfilled without the need to increase the number of delivery resources, providing increased efficiency (e.g., fewer vehicles, less fuel consumed etc.). Furthermore, the methods described herein can be implemented with minimal additional processing over that required to configure and manage delivery resources that service a single lead time.

The deferred availability period may precede the advance availability period. The advance availability period and the deferred availability period may be consecutive.

The definition of a delivery resource may further comprise a delivery period, the deferred availability period may then comprise a first portion of the delivery period and the advance availability period may then comprise a remaining second portion of the delivery period. The delivery period may be defined by a start time and a finish time for the delivery resource.

The method may further comprise, for each delivery resource, defining the deferred availability period as a proportion of a maximum deferred availability period. The method may further comprise defining a deferred availability maximum lead time for the plurality of delivery resources and, for each delivery resource, using the deferred availability maximum lead time to determine the maximum deferred availability period. The step of using the deferred availability maximum lead time to determine the maximum deferred availability period may comprise using the deferred availability maximum lead time to determine a latest end time for the deferred availability period of the delivery resource, and defining the maximum deferred availability period as being between the start time for the delivery resource and the latest end time for the deferred availability period of the delivery resource.

The step of defining the deferred availability period as a proportion of the maximum deferred availability period may comprise defining a proportion of the maximum deferred availability period that is to be used as the deferred availability period, using the proportion of the maximum deferred availability period to determine an end time for the deferred availability period, and determining the deferred availability period as being between the start time of the delivery resource and the end time for the deferred availability period.

The definition of each delivery resource may further comprise an advance availability release time. The method may then further comprise preventing orders from being assigned to a delivery resource to the advance availability release time of the delivery resource.

The definition of each delivery resource may further comprise an advance availability capacity and a deferred availability capacity. The step of identifying delivery time slots for the order that can be fulfilled by one or more of the plurality of delivery resources may then further comprise, if an order request time is before the deferred availability release time defined for the delivery resource, determining if the advance availability capacity that has not yet been allocated is sufficient to contain the order and, if not, then excluding the delivery resource and, if an order request time is after the deferred availability release time and before the resource finalization time defined for the delivery resource, determining if a combination of the advance availability capacity and the deferred availability capacity that has not yet been allocated is sufficient to contain the order and, if not, then excluding the delivery resource.

The method may further comprise, after assigning the order to any of the plurality of delivery resources that can fulfil the selected delivery time slot, allocating a corresponding portion of the unallocated resource capacity to the order.

The definition of each of the delivery resources may further comprise a delivery zone to which the delivery resource is allocated, the delivery zone defining an area within which the delivery resource is to make deliveries. The plurality of delivery resources may be configured to service (i.e., make deliveries within) an area that is covered by a plurality of delivery zones, and the definition of each of the delivery resources further comprises one delivery zone to which the delivery resource is allocated. The step of identifying the delivery resources that are capable of delivering the order may then comprise identifying the delivery resources for which a delivery location of the order is within the delivery zone allocated to the delivery resource.

The step of identifying delivery time slots for the order that can be fulfilled by one or more of the plurality of delivery resources may further comprise, if an order request time is after the resource finalization time, excluding the delivery resource. The step of identifying any available delivery time slots may comprise identifying time slots for which the delivery resource has not already been assigned a delivery.

The method may further comprise enabling amendment of an order prior to the finalization time. The amendment of an order may comprise any of adding items to and removing items from the order. The method may further comprise, for each of the plurality of delivery resources, upon reaching the finalization time, processing the delivery resource to finalize the assignment of orders to the delivery resource. The step of processing the delivery resource to finalize the assignment of orders to the delivery resource may then comprise determining if any of the orders assigned to the delivery resource should be assigned to an alternative delivery resource. The method may further comprise, after finalizing the assignment of orders to the delivery resource, sending instructions to a storage and retrieval system to initiate fulfilment of the order.

According to a second aspect, there is provided a computer program comprising instructions which, when the program is executed by a computer, cause the computer to carry out the method according to the first aspect.

According to a third aspect, there is provided a data processing system comprising a processor configured to carry out the method according to the first aspect.

According to a fourth aspect, there is provided a system for assigning orders to delivery resources. The system comprises a storage and retrieval portion arranged to store items, a memory storing a definition for of each of a plurality of delivery resources, each delivery resource definition comprising a resource finalization time, an advance availability period, a deferred availability period, and a deferred availability release time, a transceiver arranged to receive requests and to transmit responses, and one or more processors. The one or more processors are configured to, upon receiving a delivery slot request for an order, identify delivery time slots for the order that can be fulfilled by one or more of the plurality of delivery resources, enable selection of any one of identified delivery time slots, receive a selection of one of the identified time slots and assign the order to any of the plurality of delivery resources that can fulfil the selected delivery time slot. The step of identifying delivery time slots for the order that can be fulfilled by one or more of the plurality of delivery resources comprises identifying the delivery resources that are capable of delivering the order and, for each of the identified delivery resources, if an order request time is before the deferred availability release time for the delivery resource, identifying any available delivery time slots that are within the advance availability period of the delivery resource, and if an order request time is after the deferred availability release time and before the resource finalization time, identifying any available delivery time slots that are within any of the advance availability period and the deferred availability period of the delivery resource. The one or more processors are further configured to, after the resource finalization time of the assigned delivery resource, send instructions to the storage and retrieval portion to initiate picking and packing of the order, and loading of the order on to the assigned delivery resource;

Other variations and advantages will become apparent from the following description.

### BRIEF DESCRIPTION OF THE DRAWINGS

These and other aspects of the invention will now be described, by way of example only, and with reference to the accompanying drawings, in which:

FIG. 1 is a flow diagram illustrating an example of a method of operating an order fulfilment system

FIG. 2 is a flow diagram illustrating an example of a method performed in order to identify delivery time slots for an order;

FIG. 3 is a flow diagram illustrating an alternative example of a method performed in order to identify delivery time slots for an order;

FIG. 4 is a timeline illustrating an example of the methods as described herein; and

FIG. 5 is a schematic illustration of an example of a fulfilment system that is suitable for implementing the methods described herein

In the figures, like features are denoted by like reference signs where appropriate.

### DETAILED DESCRIPTION

There will now be described methods of managing delivery resources. The methods apply to order fulfilment systems that make use of a plurality of delivery resources to deliver orders to requesting users/customers. In this regard, a delivery resource may be any means that can be used by the system to delivery an order to a delivery location requested by a user/customer. By way of example, such a delivery resource can comprise a manually operated vehicle such as a van, truck, motorcycle, moped, bicycle, drone etc. By way of further example, such a delivery resource could comprise an autonomous vehicle.

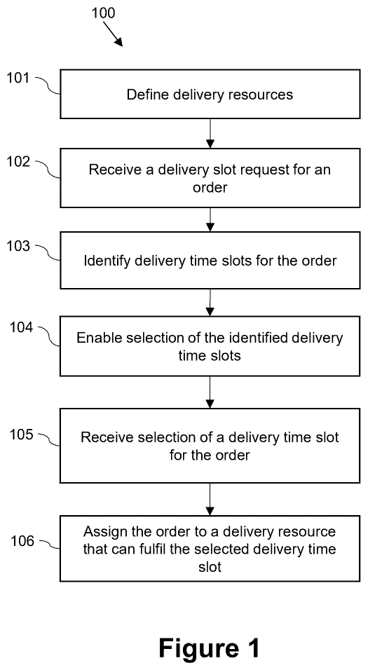

FIG. 1 is a flow diagram illustrating an example of a method 100 of operating an order fulfilment system. In particular, FIG. 1 illustrates an example of a method 100 of managing the assignment of orders to the plurality of delivery resources.

At step 101, the system is configured with a definition for each of the plurality of delivery resources that are available to the system. Specifically, within the system each delivery resource is defined as comprising a resource finalization time, an advance availability period, a deferred availability period, and a deferred availability release time. The resource finalization time is the latest time by which orders can be assigned to the delivery resource. The advance availability period is then a time period during which the delivery resource can be used to deliver orders and for which orders can be assigned to the delivery resource at any time prior to the resource finalization time. The deferred availability period is then a time period during which the delivery resource can be used to deliver orders but for which orders can only be assigned to the delivery resource after the deferred availability release time and prior to the resource finalization time.

By way of example, the step of defining the plurality of delivery resources within the system may comprise storing within the system a delivery resource record for each delivery resource. The delivery resource record of each delivery resource may then comprise all relevant information for the delivery resource, including the information that defines the delivery resource (e.g., the resource finalization time, the advance availability period, the deferred availability period, the deferred availability release time etc.).

At step 102, the system receives a delivery slot request for an order. The delivery slot request comprises at least a delivery location for the order. Typically, the delivery slot request will be received in response to a user submitting an order for delivery of one or more items to the delivery location. By way of example, the user may submit an order by selecting one or more items and identifying a delivery location for the order using a graphical user interface (GUI), such as a web page, provided by the system operator and presented on an end user device (such as a computer, smartphone, tablet etc.) of the user. The order would then be communicated to the system over a communications network. The system would then treat receipt of the order as an implicit delivery slot request.

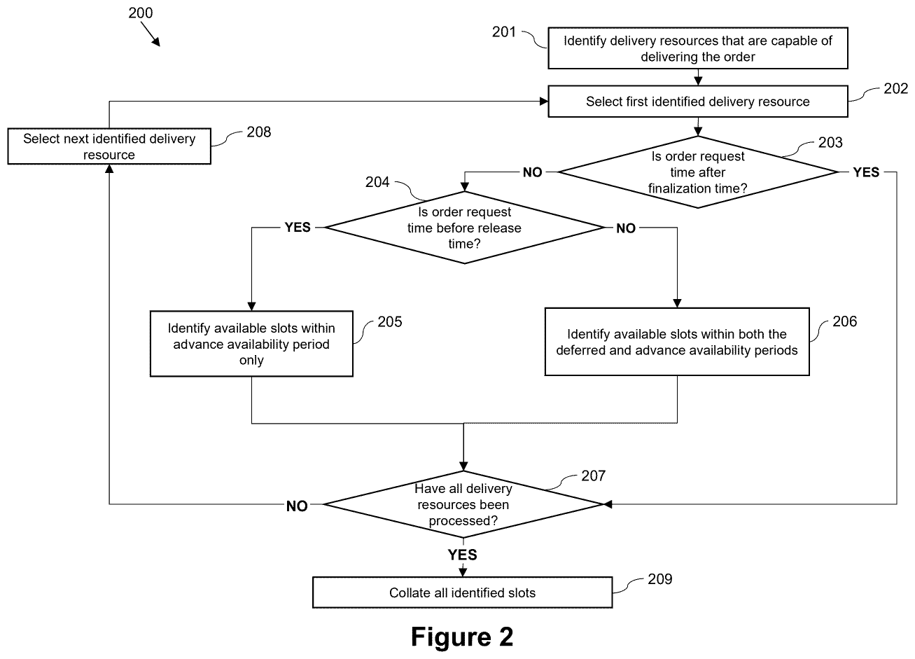

At step 103, the system identifies delivery time slots for the order that can be fulfilled by one or more of the plurality of delivery resources. According to the methods described herein, the delivery time slots considered by the system are defined independently of the delivery resources. By way of example, the system can be configured with a regular schedule of time slots each day (e.g., 1 hour time slots, starting every 30 minutes between 06:00 and 00:00). The system is therefore required to determine which of the delivery time slots can be used for delivery of the order by identifying those delivery resources that are both capable of delivering the order and available to deliver the order in the time slot. Step 103 is described in more detail below with reference to FIG. 2.

At step 104, the system enables selection of any one of the identified time slots. By way of example, the system may be configured to provide the requesting user with a timetable that is displayed on a GUI, with the timetable showing the timeslots that have been identified for the order and that allows the user to select any of the displayed time slots.

At step 105, the system receives a selection of one of the identified time slots. By way of example, the system receives a selection of one of the identified time slots that has been made by the requesting user using a GUI and that has been communicated to the system over the Internet.

At step 106, the order is then assigned to any of the plurality of delivery resources that can fulfil the selected delivery time slot. By way of example, the process of assigning an order to a delivery resource may comprise storing the assignment of the order to one of the delivery resource for the selected time slot. Subsequent requests for a delivery time slot will then be able to exclude the assigned delivery resource when determining if a particular time slot can be fulfilled by the system. In particular, the system may update the delivery resource record of the delivery resource to indicate that the delivery resource has been assigned to deliver the order in the selected time slot. The updated delivery resource record can then be used by the system to determine if the delivery resource can fulfil a particular time slot.

In a preferred implementation, the order is assigned to a delivery resource as soon as, or shortly after, receiving a selection of a delivery time slot. As will be described in more detail below, it may then be possible to reassign the order to an alternative delivery resource, e.g., in order to optimise the usage of the delivery resources.

The method may further comprise, after the resource finalization time of the assigned delivery resource, sending instructions to a storage and retrieval portion of the system to initiate picking and packing of the order, and loading of the order on to the delivery resource.

In an optional implementation, if more than one of the plurality of delivery resources can fulfil the selected delivery time slot, then the system will assign the order to one of the more than one delivery resources that has the earliest resource finalization time. This approach leaves time available on the delivery resources having a later finalization time, which then remains available for later placed orders, and maximises the usage of the delivery resources.

In another optional implementation, the system may be configured to allow the requesting user to amend the order prior to the finalization time of the assigned delivery resource. In particular, the system may be configured to allow the requesting user to add and/or remove items from the order prior to the finalization time.

In a yet further optional implementation, upon reaching the finalization time of a delivery resource, the system may process the delivery resource to finalize the assignment of orders to the delivery resource. The process of finalizing the assignment of orders to the delivery resource may comprise determining if any of the orders assigned to the delivery resource should be reassigned to an alternative delivery resource and, if so, reassigning one or more orders that have been assigned to the delivery resource to one or more alternative delivery resources. In addition, the process of finalizing the assignment of orders to the delivery resource may comprise determining if any of the orders assigned to other delivery resources should be reassigned to the delivery resource and, if so, reassigning one or more orders that have been assigned to other delivery resource to the delivery resource. By way of example, such a finalization process may reassign orders between the delivery resources in order to minimise the distance travelled and/or energy consumed by a delivery resource during the relevant delivery period. By way of further example, such a finalization process may reassign orders to maximise the capacity used and thereby minimise the number of delivery resources required to complete a number of deliveries. Any reassignment of orders between delivery resources may comprise updating the delivery resource record of any related delivery resources.

FIG. 2 is then a flow diagram illustrating an example of a method 200 performed in order to identify delivery time slots for an order that can be fulfilled by one or more of the plurality of delivery resources in accordance with the method described above with reference to FIG. 1 (step 103).

At step 201, the system identifies the delivery resources that are capable of delivering the order. By way of example, the step of identifying delivery resources that are capable of delivering the order may comprise identifying delivery resources based on any of a type of the delivery resource (e.g., van, car, moped etc.), a capacity of the delivery resource (e.g., is it large enough, is there sufficient capacity), a range of the delivery resource (e.g., is the delivery location within the range of the delivery resource), a delivery zone assigned to the delivery resource (i.e., is the delivery location within the delivery zone) etc. In some cases, it may be that all of the delivery resources are capable of delivering the order such that step 201 results in identifying all of the plurality of delivery resources. For example, all of delivery resources could be of an appropriate type, have sufficient capacity/range, and/or be assigned to service a delivery zone that includes the delivery location.

In a typical implementation, the definition of each of the delivery resources may further comprise a delivery zone to which the delivery resource is allocated, wherein the delivery zone defines an area within which the delivery resource is to make deliveries (i.e., an area that is to be serviced/covered by the delivery resource). By way of example, the system itself may be configured to service a defined area, with this area being covered by a plurality of delivery zones, and each of the delivery resources would then be allocated to one of the delivery zones. In this case, each of the delivery zones could be distinct or could partially overlap. The step of identifying the delivery resources that are capable of delivering the order may then comprise identifying the delivery resources for which a delivery location of the order is within the delivery zone allocated to the delivery resource.

To enable the system to identify delivery resources that are capable of delivering the order, the system may be configured to store a delivery resource record for each delivery resource that comprises any necessary information, such as the type, capacity, range, or assigned delivery zone of the delivery resource. The system will then check the delivery resource record for each delivery resource to identify delivery resources that are capable of delivering the order.

At step 202, the system selects a first of the identified delivery resources for processing. At step 203, it is determined if an order request time is after the resource finalization time of the delivery resource being processed. In this regard, the order request time is the time at which the order request is made or received. If the order request time is after the resource finalization time, then the delivery resource can be excluded from consideration for the order and the process proceeds to step 207. If the order request time is not after the resource finalization time, then the process proceeds to step 204.

At step 204, it is determined if an order request time is before the deferred availability release time for the delivery resource. If the order request time is before the deferred availability release time, then the process proceeds to step 205. At step 205, the system identifies any available delivery time slots that are within the advance availability period of the delivery resource before proceeding to step 207. If the order request time is after the deferred availability release time, then the process proceeds to step 206. At step 206, the system identifies any available delivery time slots that are within any of the advance availability period and the deferred availability period of the delivery resource before proceeding to step 207. In both step 205 and step 206, the step of identifying any available delivery time slots comprises identifying time slots for which the delivery resource has not already been assigned a delivery. For example, this may involve checking the delivery resource record of the delivery resource.

At step 207, the system determines if all of the identified delivery resources have been processed. If not all of the identified delivery resources have been processed then the process proceeds to step 208, wherein the next identified delivery resource is selected for processing before returning to step 202. If all of the identified delivery resources have been processed then the process proceeds to step 209. At step 209, the system then collates together all of the identified delivery time slots as delivery time slots for the order that can be fulfilled by one or more of the plurality of delivery resources. The system then enables selection of any one of these identified time slots for the order (step 104).

In the above-described implementations, the deferred availability period precedes the advance availability period. The deferred availability release time may then be configured such that the deferred availability period is reserved for short lead time orders (e.g., orders having a lead time of less than 8 hours, and preferably of no more than 6 hours) whilst the advance availability portion is available for longer lead time orders. In the above-described implementations, the advance availability period and the deferred availability period are provided by a single instance of a delivery resource and are consecutive (i.e., occur one after the other without significant interruption).

In an optional implementation, each delivery resource is defined as comprising a delivery period that specifies the time during which the delivery resource can be used to deliver orders. In particular, the delivery period can be defined using a start time and a finish time for the delivery resource, with the delivery resource being available to deliver orders from the start time to the finish time. The deferred availability period may then comprise a first portion of the delivery period and the advance availability portion a remaining second portion of the delivery period. The deferred availability period may then be defined by the start time of the delivery resource and an end time of the deferred availability period, with advance availability portion being defined by the end time of the deferred availability period and the finish time of the delivery resource.

In an optional implementation, for each delivery resource, the deferred availability period may be defined as a proportion of a maximum deferred availability period. The maximum deferred availability period is then the maximum time during the delivery period for which the delivery resource can be reserved for orders submitted after the deferred availability release time. This is particularly relevant for implementations in which the deferred availability period is reserved for short lead time orders. The maximum deferred availability period would then be dependent upon the maximum lead time that is applicable to these short lead time orders, with the maximum lead time being the maximum possible time between receiving an order and delivering the order. By way of example, if short lead time orders are defined as orders having a maximum lead time of 6 hours, then the maximum deferred availability period is that portion of the delivery period that falls within 6 hours of the resource finalization time. The maximum lead time for orders that can make use of the deferred availability period may therefore be used to determine a latest end time for the deferred availability period. The maximum deferred availability period may then be defined as being from the start time of the delivery resource to the latest end time for the deferred availability period.

Defining the deferred availability period as a proportion of the maximum deferred availability period may therefore comprise defining a proportion of the maximum deferred availability period that is to be used as the deferred availability period, using the proportion of the maximum deferred availability period to determine an end time for the deferred availability period, and defining the deferred availability period as being between the start time of the delivery resource and the end time for the deferred availability period.

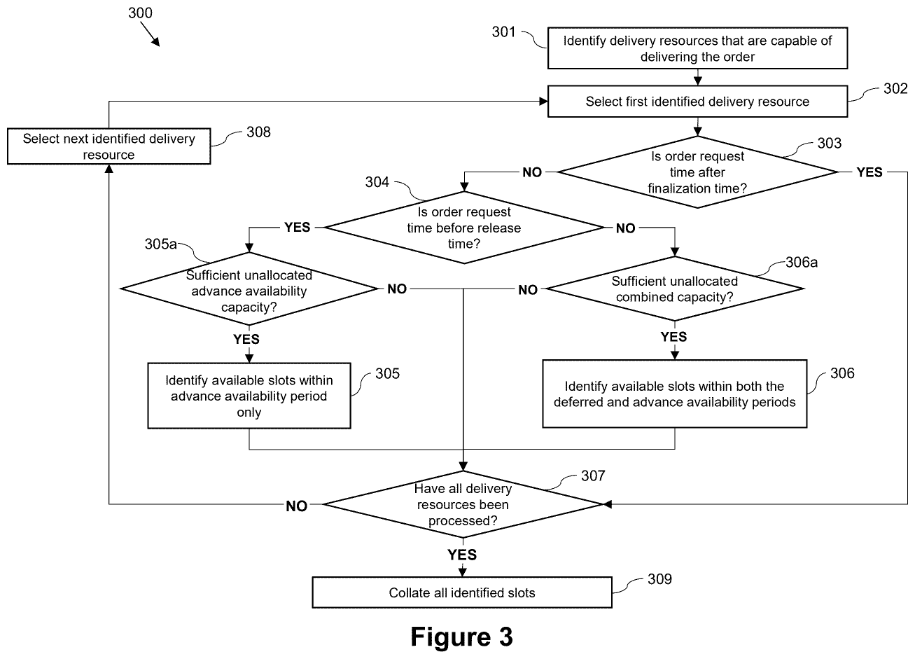

FIG. 3 is a flow diagram illustrating an alternative example of a method 300 performed in order to identify delivery time slots for an order that can be fulfilled by one or more of the plurality of delivery resources in accordance with the method described above with reference to FIG. 1 (step 103). With the exception of the steps 305a and 306a, the steps of the method FIG. 3 are the same as those of FIG. 2, so for the sake of brevity the remaining steps will not be described again here.

In the method of FIG. 3, in addition to reserving a deferred availability period of a delivery resource for deferred availability orders, the system is configured to reserve at least some of the delivery resource capacity for deferred availability orders. In this regard, the capacity of a delivery resource may be defined as the maximum volume and/or weight that the delivery resource can contain. Each order may then also have an order size that specifies an estimated volume and/or weight for the order. For example, the order size may be estimated by calculating the sum of the volume and/or weight of each item in the order based on item size information stored by the system. Then, when an order has been assigned to a delivery resource, the delivery resource record stored by the system is updated to indicate that a portion of the delivery resource capacity that is at least equal to the order size has been allocated to that order, such that the delivery resource record indicates the resource capacity that is currently unallocated and is therefore available to receive further orders.

To reserve some of the delivery resource capacity for deferred availability orders, the definition of each delivery resource may then further comprise an advance availability capacity and a deferred availability capacity. By way of example, the deferred availability capacity may then comprise a first portion of the delivery resource capacity and the advance availability capacity a remaining second portion of the delivery resource capacity. Then, when determining if a delivery resource can fulfil any delivery time slots for an order, the system will determine if the delivery resource has sufficient capacity available to receive/contain the order.

Specifically, when determining if a delivery resource can fulfil any delivery time slots for an order, if the order request time is before the deferred availability release time for a delivery resource (step 304), then the process illustrated in FIG. 3 proceeds to step 305a. At step 305a, the system determines if the advance availability capacity that has not yet been allocated is sufficient to contain the order. If the advance availability capacity that has not yet been allocated is not sufficient to contain the order, then the delivery resource is excluded from consideration for the order and the process proceeds to step 307. If the advance availability capacity that has not yet been allocated is sufficient to contain the order, then the process proceeds to step 305. At step 305, the system identifies any available delivery time slots that are within the advance availability period of the delivery resource before proceeding to step 307.

If the order request time is after the deferred availability release time, then the process proceeds to step 306a. At step 306a, the system determines if a combination of the advance availability capacity and the deferred availability capacity that has not yet been allocated is sufficient to contain the order. If the combination of the advance availability capacity and the deferred availability capacity that has not yet been allocated is not sufficient to contain the order, then the delivery resource is excluded from consideration for the order and the process proceeds to step 307. If the combination of the advance availability capacity and the deferred availability capacity that has not yet been allocated is sufficient to contain the order, then the process proceeds to step 306. At step 306, the system identifies any available delivery time slots that are within any of the advance availability period and the deferred availability period of the delivery resource before proceeding to step 307.

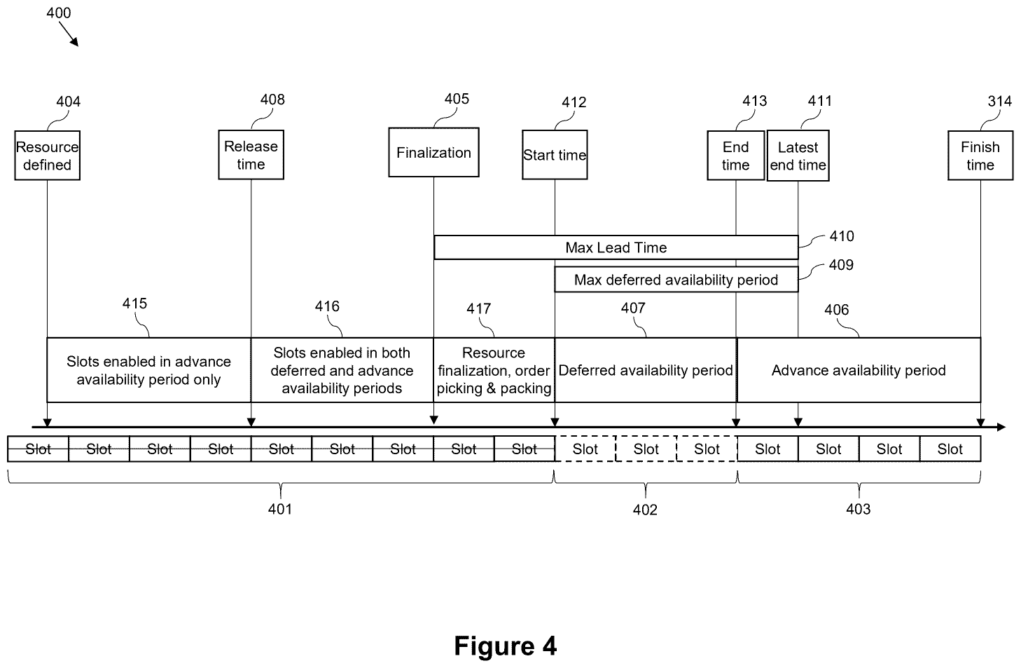

FIG. 4 is a timeline 400 illustrating an example of the methods as described herein. FIG. 4 shows a plurality of delivery time slots 401, 402, 403 relative to a delivery resource that has been defined for the system at time 404. The definition of the delivery resource comprises a resource finalization time 405, an advance availability period 406, a deferred availability period 407, and a deferred availability release time 408.

In this example, the deferred availability period 407 has been defined as a proportion of a maximum deferred availability period 409 for the delivery resource, with the maximum deferred availability period 409 having been determined from a deferred availability maximum lead time 410 that has been defined for the system. As detailed above, the resource finalization time 405 and the deferred availability maximum lead time 410 can be used to determine a latest end time 411 for the deferred availability period 407. The maximum deferred availability period 409 can then be defined as being from a start time 412 defined for the delivery resource to the latest end time 411. The proportion of a maximum deferred availability period 409 for the delivery resource can then be used to determine the actual end time 413 that is to be used for the deferred availability period 407 of the delivery resource. The advance availability period 406 may then be defined as being between the end time 413 of the deferred availability period 407 and a finish time 414 defined for the delivery resource.

This approach provides that a deferred availability maximum lead time can be defined for the system, such that this is applied to all delivery resources and can be used to determine the maximum deferred availability period for each delivery resource based on the defined finalization time. The deferred availability period for each delivery resource can then be specified by merely defining a proportion (e.g., a percentage) of the maximum that is to be reserved for deferred availability orders.

In an alternative example, the definition of a delivery resource could comprise a start time and a finish time for the delivery resource, thereby defining a delivery period during which the delivery resource is able to make deliveries, and an end time for the deferred availability period. The deferred availability period could then be implicitly defined as being between the start time and the deferred availability end time, with the advance availability period implicitly defined as being between the deferred availability end time and the finish time of the delivery period. However, this approach requires that the system administrator(s) that define the delivery resources would need to ensure that the deferred availability end time is appropriate for each and every delivery resource. For example, when defining each delivery resource, a system administrator might need to ensure that the deferred availability end time does not exceed any applicable maximum lead time for deliveries that are to be made during the deferred availability period.

As described above, the delivery time slots considered by the system are defined independently of the delivery resources. The plurality of delivery time slots 401, 402, 403 therefore comprise a first set of time slots 401 that cannot be fulfilled by the delivery resource as they occur before the start time 412 of the delivery resource, a second set of time slots 402 that fall within the deferred availability period 407 of the delivery resource, and a third set of time slots 403 that fall within the advance availability period 406 of the delivery resource.

The time prior to the start time 412 of the delivery resource therefore comprises a first period 415 during which the delivery resource is only enabled for the time slots 403 that fall within the advance availability period 406 of the delivery resource, a second time period 416 during which the delivery resource is enabled for time slots 402, 403 that fall within both the deferred availability period 407 and the advance availability period 406 of the delivery resource, and a third time period 417 during which orders cannot be assigned to the delivery resource. The third time period 417 is between the finalization time 405 and the start time 412 of the delivery resource, and during this time the orders assigned to the delivery resource are finalized and those assigned orders are picked, packed and loaded onto the delivery resource.

In the example of FIG. 4, the first period 415 extends from the time 404 at which the delivery resource is defined until the deferred availability release time 408. In other words, the system is configured such that orders can be assigned to the delivery resource for delivery during the advance availability period 406 as soon as the delivery resource has been defined within the system. However, in an alternative implementation, the definition of each delivery resource may further comprise an advance availability release time (not shown) and the system may then be configured such that orders cannot be assigned to the delivery resource prior to the advance availability release time. The system would then require that the advance availability release time is after the time 404 at which delivery resource is defined and before the deferred availability release time 408. As a consequence, prior to the advance availability release time, the system would not allow orders to be assigned to the delivery resource. Then, during the period between the advance availability release time and the deferred availability release time 408, the system would only allow orders to be assigned to the delivery resource for delivery within the advance availability period 406. During the period between the deferred availability release time 408 and the resource finalization time 405, the system would then allow orders to be assigned to the delivery resource for delivery within both the advance availability period 406 and the deferred availability period 407.

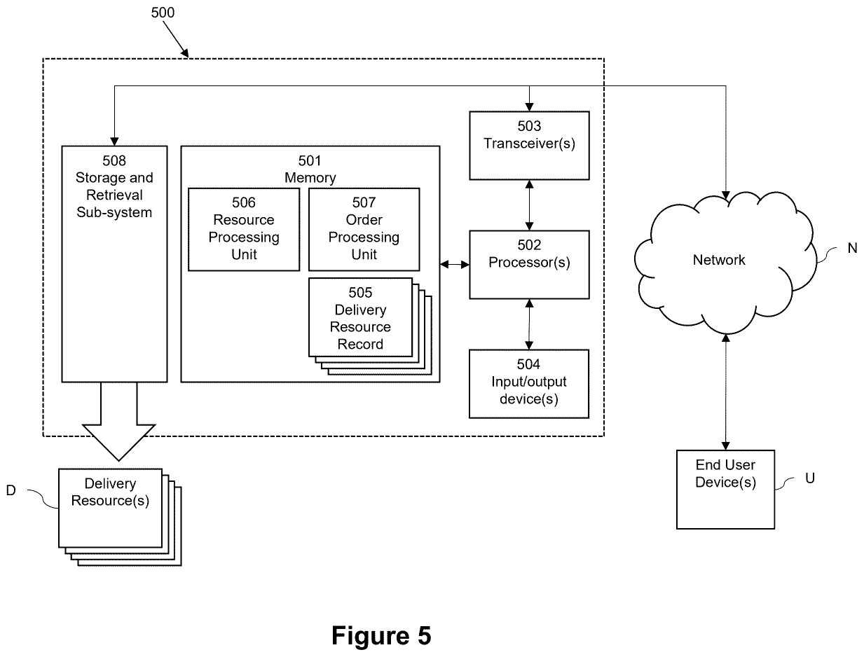

FIG. 5 is a schematic illustration of an example of a fulfilment system 500 that is suitable for implementing the methods described above. As a schematic illustration, FIG. 5 only shows the elements and functional entities that are required for understanding the arrangement with other components having been omitted for the sake of simplicity. Consequently, the implementation of the elements and functional entities may vary from that shown in FIG. 5. The connections shown in FIG. 5 are logical connections, and the actual physical connections may be different. It is apparent to a person skilled in the field that the arrangement may also comprise other functions and structures.

In the example of FIG. 5, the fulfilment system 500 is implemented as a combination of hardware and software. The fulfilment system 500 comprises a memory 501, one or more processors 502, one or more transceivers 503 and one or more input/output devices 504.

The memory 501 stores the various programs/computer-executable instructions that are implemented by the processor(s) 502. The memory 501 also provides a storage unit for any required data such as a delivery resource record 505 for each of the delivery resources (D) that are available to the system 500. As described above, the delivery resource record 505 of each of the delivery resources may comprise information that defines the delivery resource within the system 500 (e.g., the resource finalization time, the advance availability period, the deferred availability period, the deferred availability release time etc.), information relating to any orders that have been assigned to the delivery resource, and any other relevant information such as the type, capacity, range, or assigned delivery zone of the delivery resource. The memory 501 may also store any system configuration data such as a max lead time, data specifying the delivery area covered by the fulfilment system 500 and/or the delivery zones that are to be serviced by each of the delivery resources (D). The memory 501 may also store additional data such as one or more of item information for each of the items that can be delivered by the system 500 (e.g., an electronic catalog of the items), and order request records providing details of each requested order, including the items orders, the requested delivery location, and the requested delivery slot. By way of example, when an order has been assigned to a delivery resource, the delivery resource record of the delivery resource may be updated to refer to the order request record of the assigned order.

The programs/computer-executable instructions stored in the memory 501, and implemented by the processor(s) 502, include but are not limited to a delivery resource processing unit 506 and an order processing unit 507. The processor(s) 502 are then configured to execute the programs/computer-executable instructions stored in the memory 501 and in doing so control at least the memory 501, the one or more transceivers 503 and the one or more input/output devices 504.

The delivery resource processing unit 506 is configured to enable a system administrator to define the delivery resources within the system 500 and to define any relevant system preferences (such as a maximum lead time), to maintain the delivery resource record 505 of each delivery resource, and to finalize each delivery resource upon reaching the resource finalization time.

The order processing unit 507 is then configured to process orders received from requesting users, including identifying potential delivery resources for an order and assigning a delivery resource to an order upon receiving the selection of a timeslot from a requesting user. To do so, the order processing unit 507 may be configured to provide and/or support a graphical user interface through which the user interacts with the system to request an order, to select a desired delivery timeslot for the order etc. In addition, the order processing unit 507 may be configured to interface with a storage and retrieval system in order to obtain the items for the order. In particular, the order processing unit 507 may be configured to send instructions to a storage and retrieval portion of the system 500 to initiate picking and packing of the order, and loading of the order on to the assigned delivery resource. The fulfilment system 500 may therefore further comprise a storage and retrieval subsystem 508 that is arranged to store the items that can be provided by the fulfilment system 500 and to enable the stored items to be retrieved, packaged (if required) and loaded onto the assigned delivery resource (D).

The one or more transceivers 503 are then configured to enable the fulfilment system 500 to communicate. In particular, the one or more transceivers 503 are configured to enable the fulfilment system 500 to communicate with end user devices (U) or one or more users over a communications network (N) such as the Internet, a Local Area Network, a Wide Area Network etc. The one or more transceivers 503 thereby enable the fulfilment system 500 to receive delivery slot requests and/or order information from requesting users, and the selection of an identified time slot for delivery of an order. The one or more transceivers 503 may also be used to transmit item information, available delivery time slot information etc. to requesting users.

The one or more input/output devices 504 are then configured to allow system administrators to interact with the fulfilment system 500. In particular, these input/output devices 504 enable system administrators to configure the system 500 with definitions for each of the delivery resources (D) and with any other system configuration data.

It will be appreciated that various features described herein can take the form of a computer program embodied as a computer-readable medium having computer executable code for use by or in connection with a computer. For the purposes of this description, a computer readable medium can be any tangible apparatus that can contain, store, communicate, propagate, or transport the program for use by or in connection with the computer. Moreover, a computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The flow diagrams in the figures illustrate the architecture, functionality, and operation of possible implementations of methods according to various implementations. In this regard, each block in the flow diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the flow diagrams, and combinations of blocks in the flow diagrams, can be implemented by special purpose hardware-based systems that perform the specified functions or acts, or combinations of special purpose hardware and computer instructions.

It will be appreciated that the features described hereinabove may all be used together in a single system. In other embodiments of the invention, some of the features may be omitted. The features may be used in any compatible arrangement. Many variations and modifications not explicitly described above are possible without departing from the scope of the invention as defined in the appended claims.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

1. A method of managing delivery resources, the method comprising:
for each of a plurality of delivery resources, defining a resource finalization time, an advance availability period, a deferred availability period, and a deferred availability release time;
upon receiving a delivery slot request for an order, identifying delivery time slots for the order that can be fulfilled by one or more of the plurality of delivery resources, enabling selection of any one of identified delivery time slots, receiving a selection of one of the identified time slots and assigning the order to any of the plurality of delivery resources that can fulfil the selected delivery time slot; and
after the resource finalization time of the assigned delivery resource, sending instructions to a storage and retrieval portion of the system to initiate picking and packing of the order, and loading of the order on to the delivery resource;
wherein the step of identifying delivery time slots for the order that can be fulfilled by one or more of the plurality of delivery resources comprises:
identifying the delivery resources that are capable of delivering the order;
for each of the identified delivery resources:
if an order request time is before the deferred availability release time defined for the delivery resource, identifying any available delivery time slots that are within the advance availability period of the delivery resource; and
if an order request time is after the deferred availability release time and before the resource finalization time defined for the delivery resource, identifying any available delivery time slots that are within any of the advance availability period and the deferred availability period of the delivery resource.

2. The method of claim 1, wherein the deferred availability period precedes the advance availability period.

3. The method of claim 2, further comprising, for each of the plurality of delivery resources, defining a delivery period, and defining the deferred availability period as a first portion of the delivery period and the advance availability period as a remaining second portion of the delivery period.

4. The method of claim 3, wherein the delivery period is defined by a start time and a finish time for the delivery resource.

5. The method of claim 4, further comprising:
for each delivery resource, defining the deferred availability period as a proportion of a maximum deferred availability period.

6. The method of claim 5, further comprising:
defining a deferred availability maximum lead time for the plurality of delivery resources; and
for each delivery resource, using the deferred availability maximum lead time to determine the maximum deferred availability period.

7. The method of claim 6, wherein the step of using the deferred availability maximum lead time to determine the maximum deferred availability period comprises:
using the deferred availability maximum lead time to determine a latest end time for the deferred availability period of the delivery resource, and defining the maximum deferred availability period as being between the start time for the delivery resource and the latest end time for the deferred availability period of the delivery resource.

8. The method of claim 5, wherein defining the deferred availability period as a proportion of the maximum deferred availability period comprises:
defining a proportion of the maximum deferred availability period that is to be used as the deferred availability period;
using the proportion of the maximum deferred availability period to determine an end time for the deferred availability period; and
defining the deferred availability period as being between the start time of the delivery resource and the end time for the deferred availability period.

9. The method of claim 8, further comprising:
for each of a plurality of delivery resources, defining an advance availability capacity and a deferred availability capacity, and wherein the step of identifying delivery time slots for the order that can be fulfilled by one or more of the plurality of delivery resources further comprises:
if an order request time is before the deferred availability release time defined for the delivery resource, determining if the advance availability capacity that has not yet been allocated is sufficient to contain the order and, if not, then excluding the delivery resource; and
if an order request time is after the deferred availability release time and before the resource finalization time defined for the delivery resource, determining if a combination of the advance availability capacity and the deferred availability capacity that has not yet been allocated is sufficient to contain the order and, if not, then excluding the delivery resource.

10. The method of claim 9, further comprising:
after assigning the order to any of the plurality of delivery resources that can fulfil the selected delivery time slot, allocating a corresponding portion of the unallocated resource capacity to the order.

11. The method of claim 1, wherein the definition of each of the delivery resources further comprises a delivery zone to which the delivery resource is allocated, the delivery zone defining an area within which the delivery resource is to make deliveries.

12. The method of claim 11, wherein the plurality of delivery resources is configured to service an area that is covered by a plurality of delivery zones, and the definition of each of the delivery resources further comprises one of the plurality of delivery zone to which the delivery resource is allocated.

13. The method of claim 12, wherein the step of identifying the delivery resources that are capable of delivering the order comprises:
identifying the delivery resources for which a delivery location of the order is within the delivery zone allocated to the delivery resource.

14. The method of claim 13, wherein the step of identifying delivery time slots for the order that can be fulfilled by one or more of the plurality of delivery resources further comprises:
if an order request time is after the resource finalization time defined for the delivery resource, excluding the delivery resource.

15. The method of claim 14, wherein the step of identifying any available delivery time slots comprises:
identifying time slots for which the delivery resource has not already been assigned a delivery.

16. The method of claim 15, further comprising:
for each of the plurality of delivery resources, upon reaching the finalization time, processing the delivery resource to finalize the assignment of orders to the delivery resource.

17. A computer program comprising instructions which, when the program is executed by a computer, cause the computer to carry out the method of claim 1.

18. A non-transitory computer-readable medium including the computer program of claim 17.

19. A system for managing delivery resources, the system comprising:
a storage and retrieval portion arranged to store items;
a memory storing a definition for each of a plurality of delivery resources, each definition comprising a resource finalization time, an advance availability period, a deferred availability period, and a deferred availability release time;
a transceiver arranged to receive requests and to transmit responses; and
one or more processors configured to, upon receiving a delivery slot request for an order, identify delivery time slots for the order that can be fulfilled by one or more of the plurality of delivery resources, enable selection of any one of identified delivery time slots, receive a selection of one of the identified time slots and assign the order to any of the plurality of delivery resources that can fulfil the selected delivery time slot;
wherein the one or more processors are further configured to, after the resource finalization time of the assigned delivery resource, send instructions to the storage and retrieval portion to initiate picking and packing of the order, and loading of the order on to the assigned delivery resource;
wherein the step of identifying delivery time slots for the order that can be fulfilled by one or more of the plurality of delivery resources comprises:
identifying the delivery resources that are capable of delivering the order;
for each of the identified delivery resources:
if an order request time is before the deferred availability release time defined for the delivery resource, identifying any available delivery time slots that are within the advance availability period of the delivery resource; and
if an order request time is after the deferred availability release time and before the resource finalization time defined for the delivery resource, identifying any available delivery time slots that are within any of the advance availability period and the deferred availability period of the delivery resource.
